(19) United States
(12) Patent Application Publication
(10) Pub. No.: US 2022/0358032 A1
(43) Pub. Date: Nov. 10, 2022

(54) COMPUTER-IMPLEMENTED METHOD FOR AUTOMATICALLY PROVIDING AN ADVICE FOR TEST PROCESSES

(71) Applicant: dSPACE GmbH, Paderborn (DE)

(72) Inventors: Eduard MILLER, Paderborn (DE); Steffen BERINGER, Paderborn (DE); Sebastian BANNENBERG, Paderborn (DE); Markus DEPPE, Paderborn (DE)

(73) Assignee: dSPACE GmbH, Paderborn (DE)

(21) Appl. No.: 17/735,219

(22) Filed: May 3, 2022

(30) Foreign Application Priority Data
May 4, 2021 (DE) 10 2021 111 463.2

(51) Int. Cl. G06F 11/36; G06F 11/34

(52) U.S. Cl. CPC G06F 11/3684; G06F 11/3688; G06F 11/3457

(57) ABSTRACT

A computer-implemented method for the automatic provision of an Advice for test processes, wherein the Advice is determined by at least one Advice-generator and the Advice-generator for tests and/or simulations is selected manually and/or automatically, wherein the Advice-generator monitors at least two test runs, so that at least one event is detected in the test runs and at least one Advice is derived, wherein the Advice-generator is executed automatically by an Advice-generator mechanism during test runs and an Advice determined by the Advice-generator is provided to the test system and/or a user.

This nonprovisional application claims priority under 35 U.S.C. § 119(a) to German Patent Application No. 10 2021 111 463.2, which was filed in Germany on May 4, 2021, and which is herein incorporated by reference.

### BACKGROUND OF THE INVENTION

### Field of the Invention

The present invention relates to a computer-implemented method for the automatic provision of an Advice for test processes, wherein the Advice is determined by at least one Advice-generator and the Advice-generator is selected manually and/or automatically for tests and/or simulations. The Advice-generator monitors several test runs, but at least two test runs, so that at least one event is detected in the test runs and at least one Advice is derived. The Advice-generator is automatically run by an Advice-generator mechanism during test runs and an Advice determined by the Advice-generator is then provided to the test system and/or a user.

The present invention further relates to a test unit for the automatic provision of an Advice for test processes. The present invention also relates to a computer program and a computer-readable data carrier.

### Description of the Background Art

Driver assistance systems such as, e.g., adaptive cruise control and/or functions for highly automated or autonomous driving can be verified or validated using various verification methods. In particular, hardware-in-the-loop methods, software-in-the-loop methods, simulations and/or test drives can be used.

The effort involved, in particular in terms of time and/or cost, to test such vehicle functions using the above-mentioned verification methods is typically very high, as a large number of potentially possible driving situations must be tested.

For reasons of time and cost, it is not possible to test an at least partially autonomous means of transport exclusively on the road over distances of more than billions of kilometers. In addition, many redundant test kilometers would arise, while critical and unusual situations, which are relevant to the capabilities of the at least partially autonomous vehicle, might not occur.

In particular, this can lead to a high expense for test drives as well as for simulations. DE 10 2017 200 180 A1 specifies a method for the verification and/or validation of a vehicle function which is intended to autonomously guide a vehicle in the longitudinal and/or transverse direction.

The method comprises determining, based on environmental data relating to an environment of the vehicle, a test control instruction of the vehicle function to an actuator of the vehicle, wherein the test control instruction is not implemented by the actuator.

The method further comprises, based on environmental data and using a road user model with respect to at least one road user in the vicinity of the vehicle, simulating a fictitious traffic situation which would be present if the test control instruction had been implemented.

The method further includes providing test data related to the fictitious traffic situation. The vehicle function is operated passively in the vehicle to determine the test control instruction.

The disadvantage of this method is that in order to verify and/or validate the vehicle function, the vehicle actually has to be operated in order to be able to determine the required data.

Manufacturers of at least partially autonomous means of transport need a parallelized, simulation-based solution. This is where the test method “scenario-based testing” comes into play. It requires intelligent test follow-up, which evaluates simulation results and/or test data and, if necessary, implements a modified parameterization, for example.

### SUMMARY OF THE INVENTION

It is therefore an object of the invention to provide a method, a test unit, a computer program, and a computer-readable data carrier, which automatically provides an Advice for test processes. According to the invention, according to a computer-implemented method for the automatic provision of an Advice for test processes, these are determined by means of at least one Advice-generator. The Advice-generator for tests and/or simulations can be manually and/or automatically selected in an advantageous embodiment of the invention. The Advice-generator monitors several test runs, so that at least one event is detected in the test runs and at least one Advice is derived. In an advantageous embodiment, the Advice-generator is automatically executed by an Advice-generator mechanism during the test runs and an Advice determined by the Advice-generator is then provided to the test system and/or a user.

An autonomous vehicle contains a variety of control units. Each individual ECU and its network must be extensively tested during development and homologation. In order to ensure the error-free functioning of the ECUs in every traffic situation, scenario-based testing is carried out. In scenario-based testing, the driving style of the vehicle is analyzed in a traffic situation that is as realistic as possible. The aspects of the traffic situation to be analyzed and their evaluation depend on the system under test. For this purpose, scenario-based testing of systems and system components for the autonomous guidance of a motor vehicle defines scenarios that can be described as an abstraction of a traffic situation. Test cases can then be executed for each scenario. A logical scenario here is the abstraction of a traffic situation with the road, the driving behavior, and the surrounding traffic, without defining concrete parameter values. By selecting concrete parameter values, the logical scenario becomes a concrete scenario. Such a concrete scenario corresponds to a single traffic situation.

For the fundamental differentiation of the traffic scenarios or scenarios in scenario-based testing according to the invention, not only static parameters, such as, e.g., but not exclusively, environment, buildings or road width are used, but in particular also the driving behavior of the individual road users. The movements of the road users and thus the driving behavior are described by trajectories. Trajectories describe a path in both spatial and temporal directions. The movements of road users can be distinguished by means of parameters such as, e.g., speed.

An autonomous driving function is realized by a system, such as a control unit. The ECU is conventionally tested in real vehicles in real traffic situations, validated by hardware-in-the-loop tests or alternatively, by completely virtual tests. A simulation can also be used for this purpose.

A scenario to consider is, for example, a so-called cut-in scenario. The cut-in scenario can be described as a traffic situation in which a highly automated or autonomous vehicle drives in a given lane and another vehicle cuts into the Ego vehicle's lane at a certain distance at a slower speed than the Ego vehicle. The Ego vehicle here refers to the vehicle under test (SUT).

The speed of the Ego vehicle and the other vehicle, which is also referred to as the Fellow vehicle, is constant. Since the speed of the Ego vehicle is higher than that of the Fellow, the Ego vehicle must be braked to avoid a collision of the two vehicles. However, a cut-in scenario can also be present in various forms, such as, e.g., by differentiating between the speeds of the road users.

Furthermore, a scenario, such as a passing-by scenario, is possible in which the Ego vehicle represents the overtaking vehicle, so that the Ego vehicle drives in a given lane and overtakes another vehicle at a slower speed than the Ego vehicle. The Ego vehicle changes/swerves into another lane and drives past the Fellow vehicle at a higher speed. The speed of the Ego vehicle does not have to be constant in this scenario. After the Ego vehicle has passed the Fellow vehicle, the Ego vehicle swerves back into the previous lane.

Such scenarios can be simulated with different parameter values. In order to gain the highest possible knowledge about test processes, the test process must be monitored and reacted to in a test follow-up. The aim must be to obtain an evaluation of the “Subject under Test” or the “System under Test” (SUT) throughout the entire parameter range with as modest a resource investment as possible. Simulation and computing time should therefore be used in a resource-saving manner and a high test yield and homologation should be achieved. As part of the test process, a large number of comparable simulations/tests with deviating parameterization can thus be carried out. In order to make the best possible use of resources in relation to the entire test process and, above all, to ensure meaningful test conditions and meaningful parameter values in the parameter range, several test runs must be monitored. Events often occur during one or more test runs, individually or in combination, to which the user wants to react as quickly as possible.

Such a relevant event can result from correlations of the test results and/or also from, for example, capacity limits of a hard disk to be written with test results. Such an event can be detected manually by the user by observing the test process. This is very time-consuming and possibly impossible with a very high number of tests.

If test results are analyzed manually, it is not possible to react to the relevant events in a timely manner, so that the test may run too long and/or cause unnecessary costs and/or erroneously abort. Thus, the requirements and object of the invention become apparent, so that by supporting the user in the analysis and reaction to relevant events, test processes and in particular the observation of several test runs are automated and the user and/or the test system is provided with an efficient test design by means of an automatically generated Advice.

For this purpose, the invention provides in an advantageous embodiment an Advice-generator mechanism. In a further advantageous embodiment, the Advice-generators are implemented as Advice-generator plugins and the Advice-generator mechanism as an Advice-generator plugin mechanism. Other implementations are also covered by the method according to the invention.

An Advice-generator plugin mechanism, alternatively also advisor plugin mechanism, provides Advice-generator plugins, alternatively also advisor plugins. In a further embodiment, for example, Advice-generator plugins can be assigned to an Advice-generator plugin mechanism via drag & drop. An assignment is also possible according to the invention by other manual steps; furthermore, depending on the test/simulation, an automatic assignment of Advice-generator plugins can also be carried out. In addition, in particular, currently unused Advice-generator plugins can be kept and managed in an Advice-generator plugin pool.

An Advice-generator plugin includes a script and a configuration file. In addition to general data of the Advice-generator plugin such as the name, the unit of the Advice value, etc., the limits of the Advice value can be defined via the configuration file, on the basis of which the corresponding action (Advice, alert, or termination) is executed. The script is written as an Advice-generator plugin using predefined interfaces and is kept by the Advice-generator plugin mechanism after selecting the Advice-generator.

The Advice-generator plugins are kept in a database of an Advice-generator plugin pool and assigned to the Advice-generator plugin mechanism when setting up the test/simulation. During the test run, the Advice-generator plugin mechanism monitors the possible results. If new results are available, the results are collected and, if necessary, processed. Each Advice-generator plugin is then run individually. Each time the Advice-generator plugin is run, the new results are passed to the Advice-generator plugin. The Advice-provider plugin script calculates the Advice value from the results. Depending on the Advice value, an action is selected based on the limit values in the configuration and executed automatically. Both the Advice value and the action are stored in the test result.

Possible actions are, for example, an Advice or an alert to the user. In addition to the Advice, the Advice-generator plugin can also initiate a termination of the test process. All running simulations can be stopped or executed to the end. Further scheduled runs are removed from the run routine. An Advice-generator plugin also has the option of not taking any action. In this case, the Advice value is only stored in the test result.

Suppose an emergency brake assistant with three collision scenarios is to be tested. Each scenario is to be tested with 100 different concrete manifestations (concrete scenarios, sets of parameters). For example, the test definition selects two Advice-generator plugins (API-1 and API-3), each with a configuration file and script. The first Advice-generator plugin (API-1) includes the following items: when at least 10 (N) test drives have been completed, examine the collision rate in relation to the simulated test kilometers driven; in the event of at least an average of 2 (X) collisions per 1,000 km, provide the user with an Advice of the increased collision occurrence; in the event of at least 3 (Y) collisions per 1,000 km, provide the user with a warning in respect of the increased collision occurrence; in the event of at least 4 (Z) collisions per 1,000 km, terminate the test process with the scenario and start the analysis with the next test scenario; and/or if all test drives with the first scenario were run as simulations and no (0, A) collision occurred, skip the analyses of the subsequent test scenarios.

With this Advice-generator plugin (API-1), for example, the variables N, X, Y, Z and A can be selected in the configuration file.

The second Advice-generator plugin (API-2) may contain the following items: collect the run time for all test drives and calculate the average for each scenario; since the number of maximum test drives of the individual scenarios is known, the individual and summed averages of the respective run time can be used to calculate the run time of the tests of the respective scenarios; if the run length of a scenario is estimated to be longer than ⅓ of the maximum total time (G), send a warning to the user; and/or if the sum of the run lengths of each scenario exceeds the maximum total time (possibly added to an inaccuracy factor), warn the user, and terminate the entire test (termination and reprioritization).

Thanks to the Advice-generator plugins (API-1 and API-2), the test process can be designed in a resource-saving manner and tests that are unnecessarily prolonging can be detected at an early stage and reacted to accordingly.

During the test process, the individual concrete scenarios are gradually simulated. The Advice-generator plugin mechanism monitors the possible results and makes them available to the Advice-generator plugins. The Advice-generator plugins each calculate the Advice values individually and initiate the execution of the determined Advice or, alternatively, the determined Advice via the Advice-generator plugin mechanism.

Further embodiments of the present invention are the subject of the further subclaims and the following description with reference to the FIG.s.

The test unit automatically provides an Advice for test processes.

According to another aspect of the invention, a computer program with program code is further provided to carry out the method according to the invention when the computer program is executed on a computer. According to another aspect of the invention, a data carrier with program code of a computer program is provided to carry out the method according to the invention when the computer program is executed on a computer.

The features of the computer-implemented method described herein can be used to automatically provide an Advice to test processes. Also, the test unit according to the invention is suitable for carrying out a test follow-up for a variety of different devices or control units of, e.g., automobiles, commercial vehicles and/or commercial vehicles, ships, or aircraft by means of an Advice, for example, regarding simulation results and/or simulation steps for different scenarios or driving situations.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic representation for the inventive differentiation between scenarios,

FIG. 2 is a schematic view that indicates a boundary between critical and non-critical test results,

FIG. 3 is an inventive representation of an Advice-generator plugin

FIG. 4 is a schematic representation for the inventive description of the Advice-generator plugin mechanism and the Advice-generator plugin,

FIG. 5 is a schematic representation for the inventive description of the use of Advice-generator plugins,

FIG. 6 is a schematic representation for the inventive description of the use of Advice-generator plugins

FIG. 7 shows a sequence of the inventive application of the Advice-generator plugin mechanism and Advice-generator plugins, and

FIG. 8 shows possible manifestations of an inventive Advice.

### DETAILED DESCRIPTION

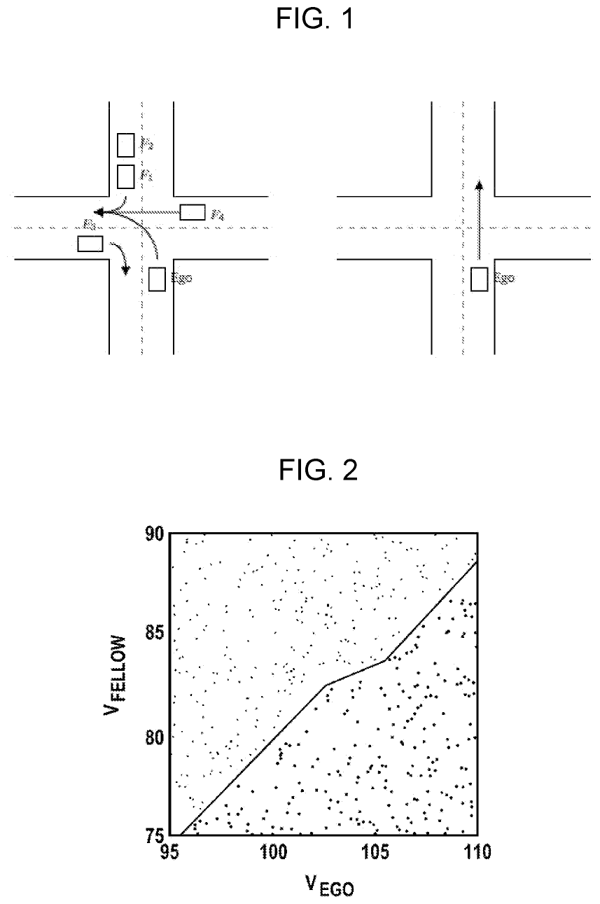

FIG. 1 describes two different scenarios S1 and S2. An intersection is displayed in each case. In both scenarios S1 and S2, an Ego vehicle (Ego) is depicted. In S1, the Ego vehicle (Ego) performs a turning maneuver. The Ego vehicle is also the “Subject under Test” or the “System under Test” (SUT). Four Fellow vehicles (F1 to F4) are involved. In S2, the Ego vehicle follows the vehicle course straight ahead without the participation of Fellow vehicles. Thus, there are differences in the scenario parameters as well as driving situation parameters. The goal in the scenarios can be, for example, the testing and simulation of adaptive cruise control.

The testing and simulation of such adaptive cruise control may require multiple test follow-ups in order to obtain a valid test result. The number of test runs yield many test results, so that relevant events can be shown over the course of the results. Relevant events can be detected via an Advice-generator plugin (API), as already presented. The Advice-generator plugin (API-1) mentioned can detect correlations in collision rates, such as:
When at least 10 (N) test drives have been completed, examine the collision rate in relation to the simulated test kilometers driven.
   With at least an average of 2 (X) collisions per 1,000 km, give the user an Advice of an increased collision occurrence.
   In the event of at least 3 (Y) collisions per 1,000 km, alert the user to the increased collision occurrence.
   In the event of at least 4 (Z) collisions per 1,000 km, abort the test process with the scenario and start the analysis with the next test scenario.
If all test drives with the first scenario were simulated and no (0, A) collision occurred, skip the analyses of the subsequent test scenarios.

With this Advice-generator plugin (API-1), for example, the variables N, X, Y, Z and A can be selected in the configuration file. Thus, different variables can be used for scenario S1 than scenario S2, but for both scenarios relevant relationships can be recognized and treated.

FIG. 2 shows a function that indicates a boundary between critical and non-critical test results. The items shown are simulated test results. Alternatively, these can also be approximated test results.

The function shown is the safety objective function, which has a numerical value that has a minimum value at a safety distance between the Ego vehicle (Ego) and the other motor vehicle, the Fellow vehicle, of ≥VFELLOW×0.55, in a collision between the Ego vehicle (Ego) and the other motor vehicle has a maximum value, and at a safety distance between the motor vehicle and the other motor vehicle of ≤VFELLOW×0.55 has a numerical value which is greater than the minimum value. Results for a safety objective function can be monitored by an Advice-generator (i.e., also by an Advice-generator plugin (API)) over several test runs, and events can be detected. For this purpose, the Advice-generator, i.e., also the Advice-generator plugin (API), is automatically executed during the test run by an Advice-generator mechanism (i.e., also by an Advice-generator plugin mechanism).

As an alternative to the safety objective function, for example, a comfort objective function or an efficiency objective function can be simulated and/or approximated, which has a numerical value with a minimum value in the event of no change in the acceleration of the motor vehicle, has a maximum value in the event of a collision between the Ego vehicle (Ego) and the other motor vehicle, and in the event of a change in the acceleration of the Ego vehicle (Ego) has a numerical value between the minimum value and the maximum value, depending on the amount of the change in acceleration. The majority of driving situation parameters, in particular the speed VEGO of the Ego vehicle (Ego) and the speed VFELLOW of the other motor vehicle, the Fellow vehicle, are generated within the given definition range, e.g., by means of a simulation.

For evaluation, variables can be defined in the configuration file of an Advice-generator plugin and also threshold values beginning with which an Advice is to be triggered. Accordingly, for example, an Advice can be triggered if an objective function has a high value over several test runs. The Advice is also configurable and can therefore be automatically executed for the test run.

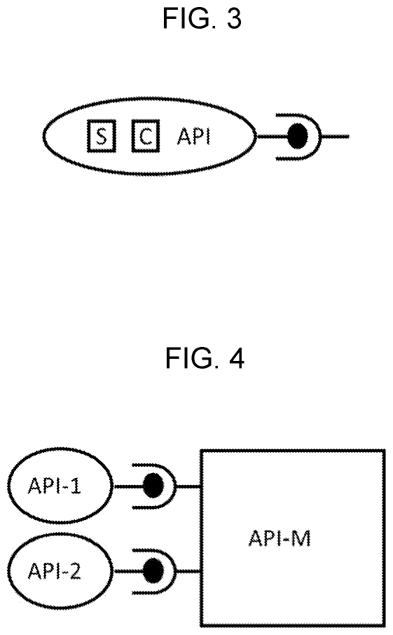

FIG. 3 shows a representation of an Advice-generator plugin (API) according to the invention. Advice-generator plugins (APIs) have an interface to the Advice-generator plugin mechanism. In addition, an Advice-generator plugin (API) consists of a configuration file (C) and an executable script (S).

The configuration file (C) provides information for monitoring different variables in the test run results and/or the test data.

In addition, the configuration file (C) determines at which Advice value an Advice should be triggered and how the Advice is configured. For example, if a defined limit is exceeded, a warning can be issued to the user and/or an Advice can be given to the test system to terminate the current test process and/or optimize storage space so that test data is not lost. This list is not considered to be exhaustive, but merely serves to clarify the possibilities of an Advice-generator plugin (API) and an Advice. The executable script (S) contains the information for determining an Advice value, which in turn determines whether and which Advice should be provided to a user and/or a test system.

FIG. 4 shows a schematic representation for the inventive description of an Advice-generator plugin mechanism (API-M). The Advice-generator plugin mechanism (API-M) controls the automatic execution of the selected Advice-generator plugins (API). All Advice-generator plugins (APIs) have a defined interface to the Advice-generator plugin mechanism (API-M). Thus, in a preferred embodiment, before starting the test and/or simulation, the user will be able to easily select Advice-generator plugins (API) for the test without further configuring the interface. The interface also ensures a simple transfer of test results and/or other test data from the respective test run to the Advice-generator plugin mechanism (API-M) and then to the selected Advice-generator plugins (API). This ensures reusability of the Advice-generator plugins (API), and the automatic execution of the Advice-generator plugins (API) represents significant time and cost savings. In addition, the test process can be optimized by early detection of relevant events in test results and/or other test data and the provision of a corresponding Advice.

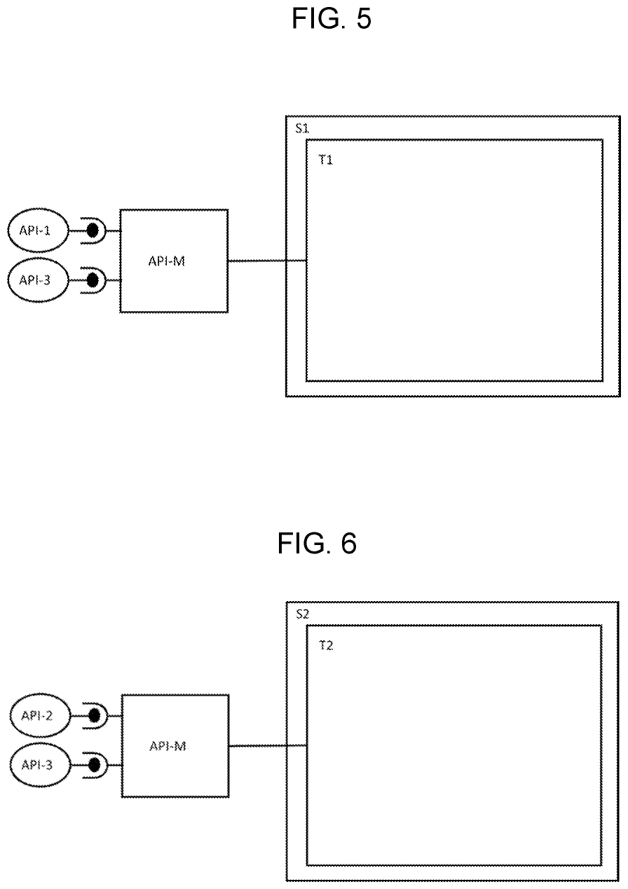

FIG. 5 shows a schematic representation for the inventive description of the use of Advice-generator plugins (API) for a concrete scenario and thus in a defined simulation/test.

For this purpose, FIG. 5 shows the Advice-generator plugin mechanism (API-M) with two Advice-generator plugins (API) API-1 and API-3. The Advice-generator plugin mechanism (API-M) is shown in conjunction with a test T1 in a scenario S1. The Advice-generator plugins (API) API-1 and API-3 are not directly linked to the scenario or the test. Their generic and dynamic definition allows for Advice-generator plugins (APIs) to be reused for various scenarios and tests. Therefore, no new Advice-generator plugin mechanism (API-M) or new Advice-generator plugin (API) is created for each new scenario or for a different test situation and/or simulation.

FIG. 6 also shows a further schematic representation for the inventive description of the use of Advice-generator plugins (API) for a concrete scenario and thus in a defined simulation/test.

Here, the Advice-generator plugin mechanism (API-M) is shown in conjunction with a test T2 in a scenario S2. FIG. 6 shows the Advice-generator plugin mechanism (API-M) with the Advice-generator plugins (API) API-2 and API-3. The Advice-generator plugins (APIs) are not directly linked to the scenario or test. It should be made clear that the Advice-generator plugin (API) API-3 can be used both in scenario S1 and test T1, as shown by FIG. 5, and in scenario S2 and thus in test T2, as shown in FIG. 6. This reuse occurs without modifying the corresponding Advice-generator plugin (API) and the associated script (S) of the Advice-generator plugin (API).

It is possible, for example, that in both the test situation shown in FIG. 5 and the test situation shown in FIG. 6, the Advice-generator plugin (API) API-3 monitors test framework conditions such as storage capacity of the storage medium which receives the test data in order to give an Advice to the test system if necessary, so that the test system can enable a further release of storage capacities. The Advice-generator plugin (API) API-1, for example, can recognize correlations in collision rates in the test results, as already presented. In addition, the Advice-generator plugin (API) API-2 can monitor the runtime of test runs in order to be able to determine cost estimates as an Advice for the user.

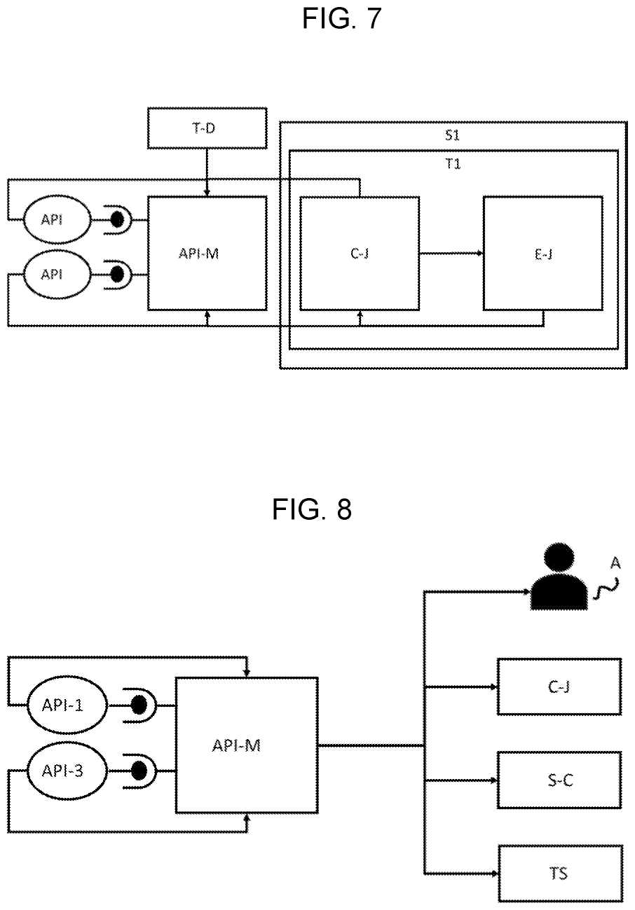

FIG. 7 shows the process of the inventive use of the Advice-generator plugin mechanism and Advice-generator plugins.

The Advice-generator plugin mechanism (API-M) receives test results from the test run (E-J), for example, for a test T1 which is executed for scenario S1. In addition, the Advice-generator plugin mechanism (API-M) can obtain additional test data (T-D) from at least one test case. This means that data from multiple test cases can also be made available to an Advice-generator plugin (API). All available information is collected and, if necessary, processed and automatically transmitted to the Advice-generator plugins (API) according to their respective configuration. Advice-Generator Plugin Mechanism (API-M) and Advice-Generator Plugin (API) have defined interfaces. The Advice-generator plugins (API) run automatically and determine an Advice value. An Advice is determined according to the Advice value and the corresponding configuration of the Advice-generator plugin (API). The Advice is implemented by the Advice-generator plugin mechanism (API-M), such as a configuration change (C-J) for future test runs.

FIG. 8 shows possible manifestations of an Advice according to the invention. The executable script (S) of an Advice-generator plugin (API) determines an Advice value. In the configuration file (C) of the Advice-generator plugin (API), both the threshold value and the characteristics of the Advice are defined.

The Advice-generator plugin mechanism (API-M) controls the automatic execution of the Advice-generator plugins (API), for example, the Advice-generator plugins API-1 and API-3 shown in FIG. 8. Furthermore, the Advice-generator plugin mechanism (API-M) takes over the execution of the determined Advice.

One manifestation of an Advice can be an alert or output to the user (A) of the test system (TS). For example, the Advice-generator plugin API-3 can monitor the runtime and thus the cost of a test process and issue an alert if a limit specified in the configuration file (C) of the Advice-generator plugin (API) is exceeded.

In addition, the manifestation of the Advice can have an effect on the configuration (C-J) of new test runs. This allows for parameter configurations to be optimized for future test runs based on events in previous test runs. Even the termination of the running test process, so that no further configuration (C-J) of test runs takes place, can be transmitted as an Advice by the Advice-generator plugin mechanism (API-M).

In addition to an Advice for the current test process, the Advice can also refer to future test processes. For example, for scenario-based testing, the selection for scenarios to be tested can be determined by an Advice-generator plugin such as API-1 from relevant events in the test results of a test process and be output either to the test system (TS) for automatic execution or to the user (A) for manual confirmation. The configuration of the scenario (S-C) can also be affected by an Advice.

The embodiments of the manifestation of the Advice is not exhaustive and further manifestations are possible according to the inventive method.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A computer-implemented method for an automatic provision of an Advice for test processes, the method comprising:
determining the Advice by at least one Advice-generator;
selecting the Advice-generator manually or automatically for tests or simulations;
monitoring, via the Advice-generator, at least two test runs so that at least one event is detected in the test runs and at least one Advice is derived;
automatically executing the Advice-generator by an Advice-generator mechanism during the test runs; and
providing an Advice determined by the Advice-generator to the test system and/or a user.

2. The computer-implemented method according to claim 1, wherein an Advice is used for test processes at least in scenario-based testing and/or homologation and/or further test methods or in requirement-based testing and/or signal-based testing.

3. The computer-implemented method according to claim 2, wherein a scenario in scenario-based testing comprises at least one test of a device for the at least partially autonomous Advice of a transporter and/or road user.

4. The computer-implemented method according to claim 1, wherein at least one test and/or one simulation is determined by at least one parameter, wherein the at least one parameter includes:
a scenario parameter comprising at least one of the features: the number of and/or the width of a lane and/or curves and/or road restrictions and/or the ambient temperature; or
a driving situation parameter that describe the number and characteristics of moving objects in the scenario, comprising at least one of the features: the number of road users and/or the number of lane changes in a traffic situation and/or the speed of the road user and/or transporter.

5. The computer-implemented method according to claim 1, wherein the transporter and/or road users includes at least an Ego vehicle and/or a Fellow vehicle, wherein an Ego vehicle is the vehicle with the system under test (SUT) and a Fellow vehicle is any other vehicle.

6. The computer-implemented method according to claim 1, wherein an Advice-generator is designed as an Advice-generator plugin and an Advice-generator plugin has a defined interface to an Advice-generator plugin mechanism and an Advice-generator plugin comprises a configuration description and a script executable by a computer.

7. The computer-implemented method according to claim 6, wherein the Advice-generator plugins is selected dynamically and reusable for tests and/or simulations.

8. The computer-implemented method according to claim 1, wherein the Advice-generator mechanism is an Advice-generator plugin mechanism and contains at least one Advice-generator plugin, and wherein all Advice-generator plugins selected in the Advice-generator plugin mechanism are automatically executed for testing.

9. The computer-implemented method according to claim 1, wherein the Advice-generator plugins monitor test results and/or test data over at least two test runs of at least one test case and/or detect events in test results and/or test data and/or determine an Advice value.

10. The computer-implemented method according to claim 1, wherein an Advice-generator plugin determines an Advice value, and if in the configuration description of the Advice-generator plugin a threshold value for the Advice value is specified and if the Advice value exceeds the threshold value, the generation of an Advice is triggered.

11. The computer-implemented method according to claim 1, wherein the Advice specified according to an Advice value includes an Advice to a user and/or a termination of the test process and/or a modification of the test process by the test system, in particular by changing at least one parameter of a simulation and/or test.

12. The computer-implemented method according to claim 1, wherein an event detected by an Advice-generator plugin is identified in test results of at least two test runs and/or in test data of the at least one test run.

13. A test unit for an automatic provision of an Advice for test processes, wherein the Advice is determined by at least one Advice-generator and the Advice-generator for tests and/or simulations is selected manually and/or automatically, wherein the Advice-generator monitors at least two test runs, so that at least one event is identified in the test runs and at least one Advice is derived, wherein the Advice-generator is executed automatically by an Advice-generator mechanism during the test runs and an Advice determined by the Advice-generator is provided to the test system and/or a user.

14. A computer program comprising program code to perform the method according to claim 1 when the computer program is executed on a computer.

15. A computer-readable data carrier comprising program code of a computer program to perform the method according to claim 1 when the computer program is executed on a computer.
